(19) United States
(12) Patent Application Publication
(10) Pub. No.: US 2006/0133022 A1
(43) Pub. Date: Jun. 22, 2006

(54) Mounting assembly for front panel of computer enclosure

(75) Inventors: Yun-Lung Chen, Tu-Cheng (TW); Fa-Ming Jiang, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/153,003

(22) Filed: Jun. 14, 2005

(30) Foreign Application Priority Data
Dec. 18, 2004 (CN) 200420103133.3

(51) Int. Cl. G06F 1/16

(52) U.S. Cl. 361/683; 361/681

(57) ABSTRACT

A mounting assembly for a front panel of a computer enclosure includes a chassis (30), two positioning members (20) attached to the chassis (30) and a front panel (10) adapted to be slidably mounted to the two positioning members (20). Each positioning member (20) has at least one guiding groove (22) therein. The front panel (10) has a locking portion (16) at each end thereof. The locking portion (16) engages with the guiding groove (22) for securing the front panel (10) on the chassis (30).

### BACKGROUND OF THE INVENTION

1. Field of the Invention

The present invention relates to a mounting assembly for a front panel of a computer enclosure, and more particularly to a mounting assembly for a front panel of a computer enclosure for demounting or mounting a front panel conveniently.

2. Background of the Invention

With the advancement of science and technology, our modern society is closely linked to computer. More and more computer users hope to detach a computer enclosure conveniently for checking malfunction of hardware and repairing interior components of a computer. However, nowadays, with the tide of miniature computer enclosure, computer users are of inconvenience in operation in incommodious computer enclosure. In addition, an expanded function of the computer enclosure is also limited. Therefore, it is required that a front panel should be demounted conveniently from a chassis. A typical mounting assembly is that a front panel is directly riveted to a chassis or a front panel is integratedly molded with a chassis. However, the front panel can not be detached when necessary for installation or removal of other electronic components, which probably causes damage of the electronic components due to insufficient room.

Generally, that the front panel can not be detached can bring much trouble when computer users assemble or disassemble electronic components in incommodious computer enclosure. This also inevitably increases the assembly time. As a result, production efficiency is reduced to a certain degree. Understandably, some attempts have been taken to introduce the enclosure without screws.

What is needed, therefore, is a mounting assembly for a front panel of a computer enclosure facilitating assembly and disassembly in a chassis.

### SUMMARY

A mounting assembly for a front panel of a computer enclosure in accordance with a preferred embodiment of the present invention includes a chassis, two positioning members attached to the chassis and a front panel adapted to be slidably mounted to the two positioning members. Each positioning member has at least one guiding groove thereon. The front panel has a locking portion at each end thereof. The locking portion is engaged with the guiding groove for securing the front panel on the chassis.

Other advantages and novel features of the present invention will be drawn from the following detailed description of preferred embodiment of the present invention with the attached drawings, in which:

### BRIEF DESCRIPTION OF THE DRAWINGS

FIG. 1 is an exploded, isometric view of a mounting assembly for a front panel of a computer enclosure in accordance with a first preferred embodiment of the present invention including a front panel, two positioning members and a chassis;

FIG. 2 is an enlarged, isometric view of the positioning member of FIG. 1, but viewed from another aspect;

FIG. 3 is an pre-assembled isometric view of FIG. 1, but without the front panel;

FIG. 4 is an assembled isometric view of FIG. 1; and

FIG. 5 is an isometric view of a mounting assembly for a front panel of a computer enclosure in accordance with a second preferred embodiment of the present invention including a front panel and a positioning member.

### DETAILED DESCRIPTION OF THE INVENTION

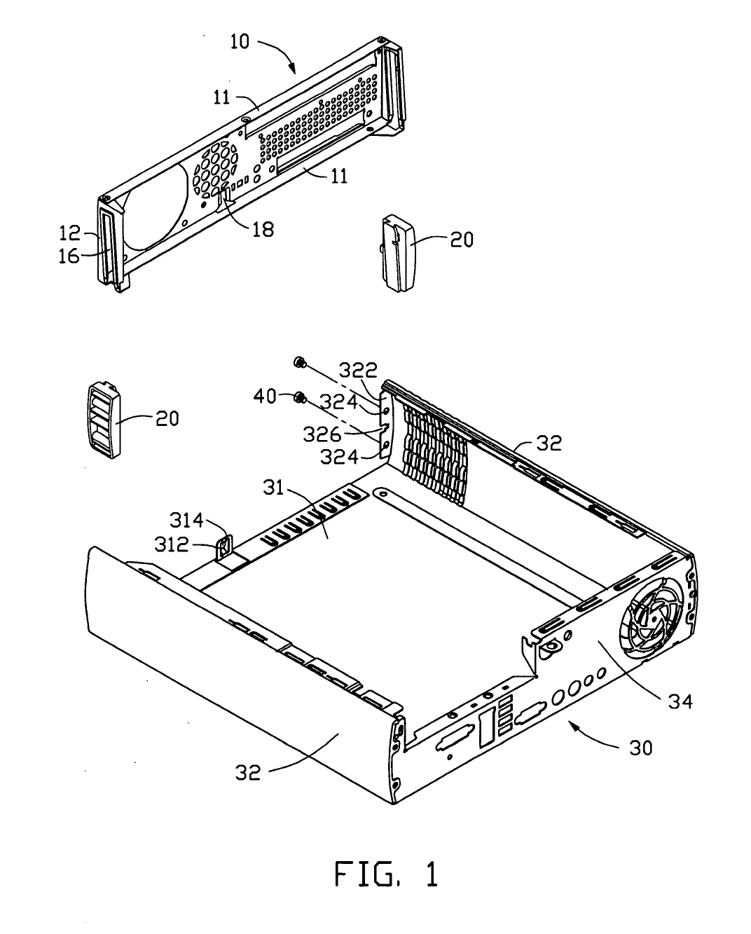

Referring to FIG. 1, a mounting assembly for a front panel of a computer enclosure in accordance with a first preferred embodiment of the present invention comprises a front panel 10, two positioning members 20, a chassis 30 and a plurality of screws 40.

The front panel 10 is bent inwardly and vertically to form a flange 11 at a top and bottom edges thereof, and the front panel 10 is also bent at opposite sides to form a flange 12 connected with the flange 11. Each flange 12 is formed to have a locking portion, and the locking portion is a generally L-shaped opening 16 in the first preferred embodiment of the present invention. The lower flange 11 defines an aperture 18 therein.

The chassis 30 includes a bottom panel 31, two opposite side panels 32 and a rear panel 34. A stopping tab 312 extends upwardly from the bottom panel 31 of the chassis 30. The stopping tab 312 is formed to have an elastic arcuate protrusion 314. Each side panel 32 of the chassis 30 is bent inwardly and vertically to form a flange 322. Two through holes 324 are defined in the flange 322. Moreover, a cutout 326 is defined in the flange 322 between the two through holes 324.

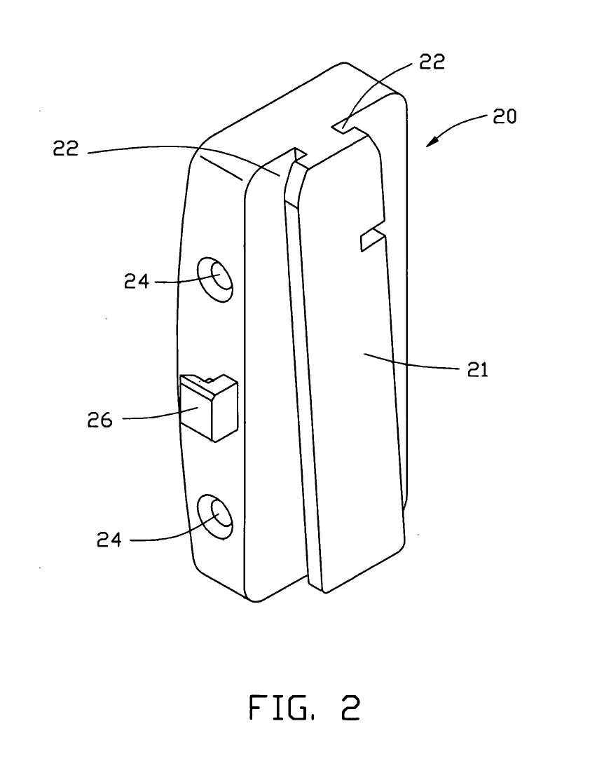

Referring to FIG. 2, a generally T-shaped block 21 extends from an inner surface of the positioning member 20. Thereby, two guiding grooves 22 are defined in the positioning member 20. The positioning member 20 also defines two screw holes 24 at a front surface thereof. Moreover, a hook 26 is formed on the positioning member 20 between the two screw holes 24.

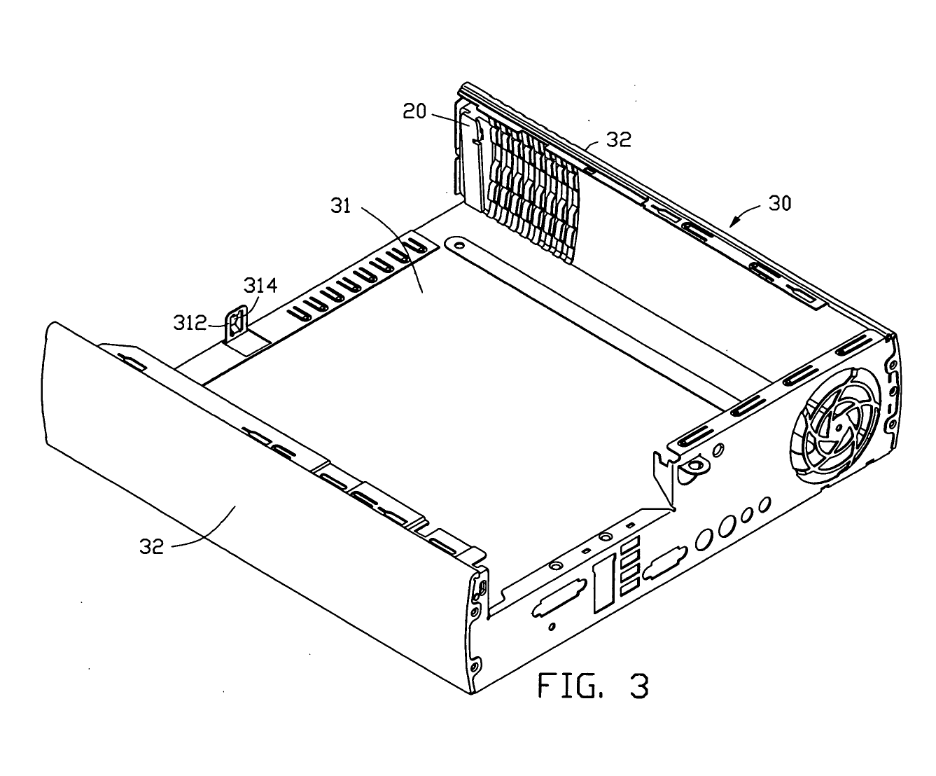

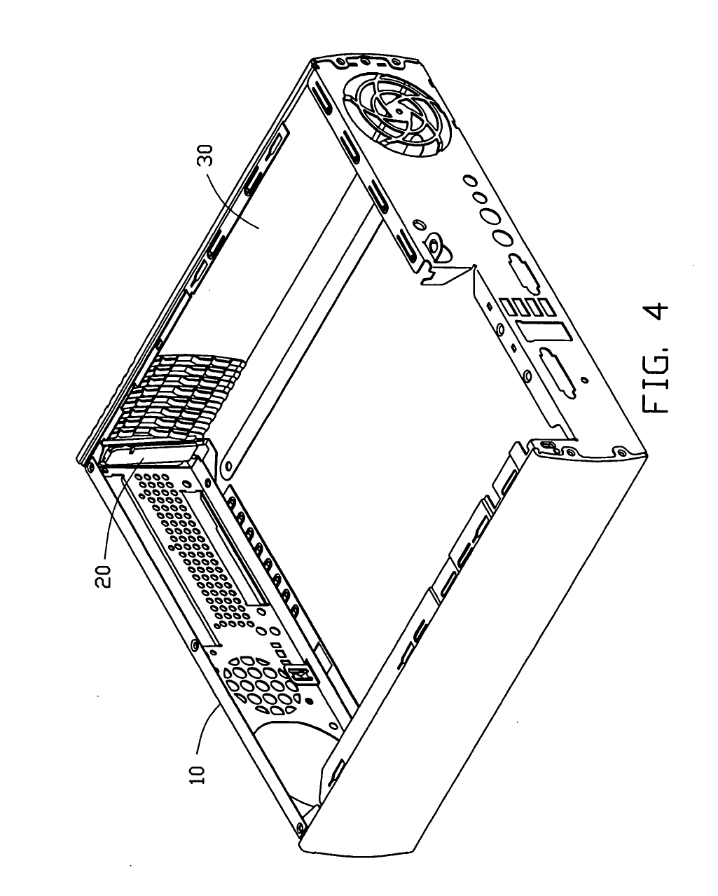

Referring also to FIGS. 3 and 4, before the front panel 10 is mounted to the chassis 30, the hook 26 of the positioning member 20 is received into the cutout 326. Then the screw holes 24 is in alignmemt with the through holes 324 of the flange 322. Subsequently, two screws 40 are extended through the through holes 324 and engage in the screw holes 24 of the positioning member 20. Therefore, the positioning member 20 is fixed to the flange 322.

In assembly of the front panel 10, the opening 16 of the flange 12 of the front panel 10 is in alignmemt with the guiding groove 22. Then, the front panel 10 is lowered to have the edges of the opening 16 sliding along the guiding groove 22. Simultaneously, the stopping tab 312 of the bottom panel 31 of the chassis 30 extends through the aperture 18 of the front panel 10. Thus, the elastic arcuate protrusion 314 abuts against the front panel 10. Therefore, the front panel 10 is prevented from moving in a front-to-back direction. Then, when the cover (not shown) is mounted on the chassis 30, the front panel 10 is consequently secured on the chassis 30.

In disassembly of the front panel 10, at first, the cover is demounted from the chassis 30. Then, when the front panel 10 is lifted, the edges of the opening 16 of the front panel 10 move upwardly along the guiding groove 22 of the positioning member 20. Finally, the edges of the opening 16 disengages from the guiding groove 22. In this manner, the front panel 10 is taken out from the chassis 30 for access to other components.

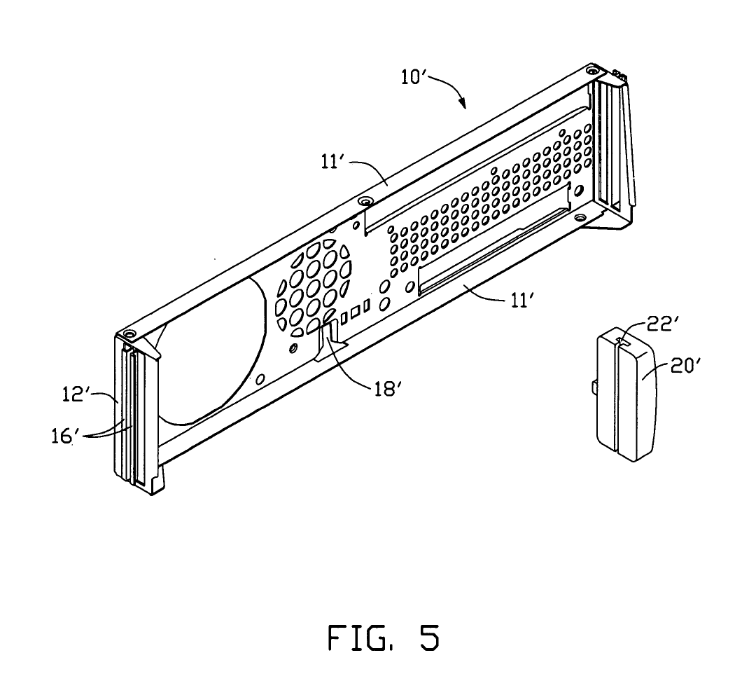

Referring to FIG. 5, a mounting assembly in accordance with a second preferred embodiment of the present invention comprises the front panel 10′, a positioning member 20′ and the chassis 30. In the second preferred embodiment of the present invention, aforementioned members such as the chassis 30 and a plurality screws 40 are the same to the first preferred embodiment of the present invention, therefore, the label of members is not changed and follows the label of members of the first preferred embodiment of the present invention.

The front panel 10′ is bent inwardly and vertically to form a flange 11′ at a top and bottom edges thereof, and the front panel 10′ is also bent at opposite sides to form a flange 12′ connected with the flange 11′. Each flange 12′ is formed to have a locking portion, and the locking portion is two opposite generally L-shaped protruding tabs 16′ in the second preferred embodiment of the present invention. The lower flange 11′ defines an aperture 18′ therein.

The positioning member 20′ is excavated to form a generally T-shaped guiding groove 22′ therethough. The positioning member 20′ also defines the same two screw holes (not labeled) as the two screw holes 24 in the first embodiment of the present invention. The positioning member 20′ is also formed to have the same a hook (not labeled) as the hook 26 in the first embodiment of the present invention.

Before the front panel 10′ is mounted to the chassis 30, a way for fixing the positioning member 20′ to the chassis 30 is the same to the way for fixing the positioning member 20 to the chassis 30.

In assembly of the front panel 10′, the two protruding tabs 16′ of the front panel 10′ are in alignmemt with the generally T-shaped guiding groove 22′. Then, the front panel 10′ is lowered to have the two protruding tabs 16′ sliding along the guiding groove 22′. Simultaneously, the stopping tab 312 of the bottom panel 31 of the chassis 30 extends through the aperture 18′ of the front panel 10′. Thus, the elastic arcuate protrusion 314 abuts against the front panel 10′. Therefore, the front panel 10′ is prevented from moving in a front-to-back direction. Then, when the cover (not shown) is mounted on the chassis 30, the front panel 10′ is consequently secured on the chassis 30.

In disassembly of the front panel 10′, the cover (not shown) is firstly demounted from the chassis 30. Then, when the front panel 10′ is lifted, the protruding tabs 16′ of the front panel 10′ move upwardly along the guiding groove 22′ of the positioning member 20′. As a result, the protruding tabs 16′ disengage with the guiding groove 22′. In this manner, the front panel 10′ is taken out from the chassis 30 for access to other components.

While the present invention has been illustrated by the description of preferred embodiment thereof, and while the preferred embodiment has been described in considerable details, it is not intended to restrict or in any way limit the scope of the appended claims to such detail. Additional advantages and modifications within the spirit and scope of the present invention will readily appear to those skilled in the art. Therefore, the present invention is not limited to the specific details and illustrative example shown and described.

We claim:

1. A mounting assembly for a front panel of a computer enclosure, comprising:
a chassis;
at least one positioning member attached to the chassis, each of the at least one positioning member having at least one guiding groove therein; and
a front panel adapted to be slidably mounted to the chassis, the front panel having a locking portion corresponding to the each positioning member for engaging with the guiding groove of the positioning member, thereby securing the front panel to the chassis.

2. The mounting assembly for a front panel of a computer enclosure as recited in claim 1, wherein the mounting assembly for a front panel of a computer enclosure further comprises a locking member for fixing the positioning member to the chassis.

3. The mounting assembly for a front panel of a computer enclosure as recited in claim 1, wherein a flange is formed at each end of the front panel, and the locking portion is formed on the flange.

4. The mounting assembly for a front panel of a computer enclosure as recited in claim 3, wherein the locking portion is an opening defined in the flange.

5. The mounting assembly for a front panel of a computer enclosure as recited in claim 4, wherein a generally T-shaped block is formed on the positioning member for inserting in the opening, thereby securing the front panel to the chassis.

6. The mounting assembly for a front panel of a computer enclosure as recited in claim 3, wherein two opposite generally L-shaped protruding tabs are formed on the flange, and the locking portion is the two generally L-shaped protruding tabs.

7. The mounting assembly for a front panel of a computer enclosure as recited in claim 6, wherein a generally T-shaped guiding groove is defined in the positioning member for the two generally L-shaped protruding tabs inserting therein.

8. The mounting assembly for a front panel of a computer enclosure as recited in claim 1, wherein each side panel of the chassis is bent inwardly to form a flange with a cutout defined, and a hook is formed on the positioning member, corresponding to the cutout for locating the positioning member.

9. The mounting assembly for a front panel of a computer enclosure as recited in claim 1, wherein a stopping tab extends upwardly from the bottom panel of the chassis, and an aperture is defined in the front panel for receiving the stopping tab.

10. A computer enclosure comprising:
a chassis comprising a bottom panel, a stopping tab extending upwardly from the bottom panel thereof;
at least one positioning member attached to the chassis, the positioning member having at least one guiding groove therein; and
a front panel adapted to be slidably mounted to the chassis, the front panel having a locking portion engagable with the guiding groove for preventing the front panel from moving in a first direction, the stopping tab abutting against the front panel for preventing the front panel from moving in a second direction different from the first direction.

11. The computer enclosure as recited in claim 10, further comprising a locking member for fixing the positioning member to the chassis.

12. The computer enclosure as recited in claim 10, wherein a flange is formed at each end of the front panel, and the locking portion is formed on the flange.

13. The computer enclosure as recited in claim 12, wherein the locking portion is an opening defined in the flange.

14. The computer enclosure as recited in claim 13, wherein a generally T-shaped block is formed on the positioning member for inserting in the opening, thereby securing the front panel to the chassis.

15. The computer enclosure as recited in the claim 12, wherein two opposite generally L-shaped protruding tabs are formed on the flange, and the locking portion is the two generally L-shaped protruding tabs.

16. The computer enclosure as recited in the claim 15, wherein a generally T-shaped guiding groove is defined in the positioning member for the two generally L-shaped protruding tabs inserting therein.

17. The computer enclosure as recited in the claim 10, wherein each side panel of the chassis is bent inwardly to form a flange with a cutout defined therein, and a hook is formed on the positioning member corresponding to the cutout for locating the positioning member.

18. A method of mounting a front panel to a chassis, comprising the steps of:
providing a chassis;
providing a positioning member attached to the chassis, the positioning member having at least one guiding groove therein;
providing a front panel comprising a locking portion at an end thereof, and
placing the front panel beside the guiding groove of the positioning member so that the locking portion of the front panel is slidably engaged with the positioning member for securing the front panel to the chassis.

19. The method as recited in the claim 18, wherein the locking portion is formed at each end of the front panel.

20. The method as recited in the claim 18, wherein a stopping tab extends upwardly from the bottom panel of the chassis, and an aperture is defined in the front panel for receiving the stopping tab.
